(19) United States
(12) Patent Application Publication
(10) Pub. No.: US 2024/0367524 A1
(43) Pub. Date: Nov. 7, 2024

(54) SOLAR ENERGY INTERMODAL CONTAINER SYSTEM AND METHODS

(71) Applicant: The Sovereign Corporation, Washington, DC (US)

(72) Inventor: Christopher MULLINGS, Washington, DC (US)

(21) Appl. No.: 18/738,965

(22) Filed: Jun. 10, 2024

Related U.S. Application Data
(63) Continuation-in-part of application No. 17/007,309, filed on Aug. 31, 2020.

(51) Int. Cl. B60L 8/00; B61C 3/00; B61L 27/10; B65D 88/12; B65D 90/06; B65D 90/22; B65G 67/20

(52) U.S. Cl. CPC B60L 8/003; B61C 3/00; B61L 27/10; B65D 88/121; B65D 90/06; B65D 90/22; B65G 67/20; B60L 2200/26; B65D 2590/0083

(57) ABSTRACT

The present disclosure describes a solar energy storage system. A storage container is provided, comprising a base having a compartment defined by a planar exterior surface and a planar interior service and a battery stored in the compartment of the base. A plurality of solar panels are operably coupled to an exterior surface of the container and electrically coupled to the battery. At least one access panel disposed in the exterior corners of the top and base and at least one plug receptacle disposed behind the at least one access panel such that each access panel is associated with one plug receptacle. The at least one plug receptacle is electrically coupled to the battery. The plurality of solar panels are configured to receive sunlight and convert to solar energy for storage in the battery and supply energy to electric vehicles during transport of the container(s).

### CROSS REFERENCES

The present application is a CIP application of and claims priority of U.S. patent application Ser. No. 17/007,309 filed on Aug. 31, 2020. The entirety of which is hereby incorporated herein by reference.

### FIELD

The present disclosure generally relates to the technical field of electrical systems and transportation. More specifically, the present disclosure is directed to a solar energy cargo system capable of receiving and storing solar energy, and powering electric or hybrid electric vehicles using the received solar energy.

### BACKGROUND

Global Climate change has been a huge focal point in recent years, and the reduction of Greenhouse Gas Emissions (GHG) has been a primary focus of Governments and Private industry alike. To prevent severe climate change, there is a need to rapidly reduce global GHG. The world emits around 50 billion tons of GHG each year. Transportation is one of the major contributors, produced by direct emissions from burning fossil fuels to power transport activities: Road transport (11.9%): emissions from the burning of petrol and diesel from linehaul transportation (semi-trucks) equates to 40% of road transport emissions that come from road freight. This means electrifying the whole road transport sector, and transitioning to a fully decarbonized electricity mix, would feasibly reduce global emissions by 11.9%, including a reduction in emissions from the burning of petrol or diesel on container ships for maritime trips of 1.7% and emissions from freight rail travel 1.4%. There are varying statistics related to how much GHG Global Transportation produces, but on average between ocean freight, rail freight, and over-the-road long haul account for 14%.

The United Nations (UN) created The Paris Agreement on Nov. 4, 2016, which was aimed at substantially reducing global GHG to limit the global temperature increase in this century to 2 degrees Celsius while pursuing efforts to limit the increase even further to 1.5 degrees. Most recently the UN on Dec. 31, 2021, concluded their Climate Change Conference in Glasgow (COP26) with continued efforts to curb GHG. Private Industry has also done its part to contribute to decreasing GHG in joining the Net-Zero Carbon by 2040 Climate Pledge. Many of the initial moves to make this happen via Government Regulation and Private Sector strategies have been aimed at vehicle manufacturing and last mile transportation delivery moving towards the Eclectic Vehicle (EV) space. This only accounts for a third of all vehicles that produce GHG globally. There have been no significant mechanisms or efforts that address the first and middle-mile transportation to include Maritime Shipping Vessels, Rail, and linehaul transportation as major contributors of GHG.

Research efforts have focused on alternative fuels, and the advancement of EV's. There are limitations to the cost-effective nature of producing biofuels for the transportation industry. Overall, it was estimated that U.S.-produced biofuels would cost between 20 and 31 times more than energy efficiency improvements that would reduce gas consumption by 1 percent. The most inhibiting drawback for EV's are their range. There is a solution that has been overlooked with regards to the latter issue. There are assets that traverse the oceans, roads, and rails daily that could be utilized to harness solar energy to power these necessary modes of transport.

Containerization has led to a significant reduction in the cost of freight transportation by eliminating the need for repeated handling of individual pieces of cargo, and improved reliability, reduced cargo theft, and cut inventory costs by shortening transit time. Containerization is a system of intermodal freight transport using intermodal containers (also called shipping containers and ISO containers). The containers have standardized dimensions. They can be loaded and unloaded, stacked, transported efficiently over long distances, and transferred from one mode of transport to another (container ships, rail transport flatcars, and semi-trailer trucks) without being opened. The handling system is completely mechanized so that all handling is done with cranes and special forklift trucks. Containers can be made from a wide range of materials such as steel, fiber-reinforced polymer, aluminum, or a combination. Containers made from weathering steel are used to minimize maintenance needs. These same assets which revolutionized the shipping industry in the mid twentieth century can now be used for another paradigm shift in global transportation.

The subject matter of the current disclosures addresses the problem of GHG emitted by transportation vehicles in the first and middle-mile global logistics network by utilizing a solar energy powered container system capable of receiving and storing solar energy and powering electric motors using the received solar energy. Because shipping containers on rail cars, semi-trailers and containerships sit outside in the sunlight all day in a yard and when in transport, they are suitable collectors of solar energy. Advances in solar powered technology have increased the durability and structure of solar panels. Solar photovoltaic (solar PV) technology captures sunlight to generate electric power. Solar PV technology has improved significantly in the last 20 years and may be utilized as the exterior walls and roof of IM containers, or attached thereto to form Solar electrified IM containers (SIM). These SIM containers are also large enough to encompass significant areas to store converted energy from the sun. In conjunction with the advances in solar powered technology, battery technology has improved tremendously in the past decade. With the advent of the lithium-ion battery and other innovative battery technologies, storage of solar energy is becoming increasingly more efficient. Alternatively, solar thermal fuels can be used to harness sunlight energy, store it as a charge and then release it when prompted. As opposed to battery technologies, the solar energy harnessed by solar thermal fuels can store power as a liquid substance. Based on how Intermodal Containerization works, the SIM container system can now power any EV that is retrofitted for operability to carry and interface with SIM containers to include Maritime Shipping Vessels, Intermodal Trains, and Semi-Trucks.

The overall global impact of this invention will not only revolutionize the transportation supply-chain industry it will allow Governments and Private industry to achieve their Climate Pledge goals by their respective deadlines. In removing the 14% of the GHG emitted by the global transportation sector, this will provide a significant positive impact to limit the global temperature increase outlined in The Paris Agreement. The adoption and implementation of the SEC system will subsequently render the age of fossil fuel powered vehicles used in first and middle-mile transportation obsolete.

An intermodal container is a large standardized shipping container, designed and built for intermodal freight transport, meaning these containers can be used across different modes of transport-from ship to rail to truck-without unloading and reloading their cargo. Terminology associated with intermodal containers may include such names as container, cargo or freight container, ISO container, shipping, sea or ocean container, sea van or (Conex) box, sea can or c can.

ISO 6346, developed by the International Container Bureau, is an international standard covering the coding, identification and marking of intermodal (“shipping”) containers used within containerized intermodal freight transport. The ISO 6346 international standard establishes a visual identification system for every container that includes a unique serial number (with check digit), the owner, a country code, a size, type and equipment category as well as any operational marks.

Similar to cardboard boxes and pallets, these containers are a means to bundle cargo and goods into larger, unitized loads, that can be easily handled, moved, and stacked, and that will pack tightly in a ship or yard. Currently, intermodal containers are made of metal and designed to be durable. Intermodal containers share a number of key construction features to withstand the stresses of intermodal shipping, to facilitate their handling and to allow stacking, as well as being identifiable through their individual unique ISO 6346 reporting mark.

Advances is solar powered technology have increased the durability and structure of solar panels. There are two main types of solar technology: photovoltaics (PV) and concentrated solar power (CSP). Solar PV technology captures sunlight to generate electric power, and CSP harnesses the sun's heat and uses it to generate thermal energy that powers heaters or turbines. Solar PV technology has improved significantly in the last 20 years. By way of example, solar PV panels can be outfitted with “solar skin”, as described in U.S. Pat. No. 10,256,360, that makes it possible for solar panels to have a customized aesthetic without interfering with efficiency or production.

Furthermore, efficiency for solar PV panels has increased tremendously. By way of example, Perovskite solar cells, as compared to silicon cells, have seen major breakthroughs, generating 20+ percent efficiency.

Intermodal container design has not changed significantly since the late 1940s. A majority of intermodal containers are stored and/or shipped exposed to the environment. It would be advantageous to configure an intermodal container such that it can receive solar energy and store that energy for future use. Moreover, with the advent of electric vehicles, it would be advantageous to be able to utilize the energy received and stored on intermodal containers to supplement electric vehicle propulsion. Finally, embodiments of the present disclosure provide that intermodal containers may be capable of receiving and storing solar energy and electrically coupled together to form a primary source of energy for electric vehicles.

### SUMMARY

According to various embodiments, the present disclosure describes a storage container, comprising a plurality of walls coupled to one another to form a storage chamber there between and to define a plurality of intersection edges being formed at a corresponding boundary of two adjacent ones of the plurality of walls. The container further comprises a base having a compartment defined by a planar exterior surface and a planar interior service; a top, wherein said plurality of walls extend substantially vertically from the base to the top; a battery stored in the compartment of the base; a plurality of solar panels operably coupled to an exterior surface of the plurality of walls and electrically coupled to the battery; at least one access panel disposed in the exterior corners of the top and base; and at least one plug receptacle disposed behind the at least one access panel such that each access panel is associated with one plug receptacle, wherein the at least one plug receptacle is electrically coupled to the battery. According to various embodiments, the plurality of solar panels are configured to receive sunlight and convert to solar energy for storage in the battery.

According to various embodiments, a solar energy storage system is disclosed. The solar energy system comprises at least one container. The at least one container comprises a top, a bottom, and a plurality of sides; at least one solar panel operably coupled to at least one of the plurality of sides of the at least one container; a battery disposed with an interior cavity of the at least one container and electrically coupled to the at least one solar panel; wherein the at least one solar panel is configured to receive sunlight and convert to solar energy for storage in the battery.

A method of powering an engine capable of receiving electricity is disclosed. The method comprises the steps of: receiving solar energy via at least one solar panel operably coupled to the exterior surface of a first intermodal container; storing the solar energy received via the at least one solar panel in a battery disposed within an interior cavity of a container; and supplying power to an electric or hybrid electric engine using the stored solar energy from the battery.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1A is a front side view of an intermodal container in accordance with some embodiments of the present disclosure.

FIG. 1B is an alternative front side view of an intermodal container in accordance with some embodiments of the present disclosure.

FIG. 1C is an interior side view of an intermodal container in accordance with some embodiments of the present disclosure.

FIG. 2 is an intermodal container operably coupled to a truck in accordance with some embodiments of the present disclosure.

FIG. 3 is a plurality of intermodal containers disposed on a container ship in accordance with some embodiments of the present disclosure.

FIG. 4 is a plurality of intermodal containers disposed on railroad car in accordance with some embodiments of the present disclosure.

FIG. 4A is a plurality of intermodal containers disposed on each other on railroad car in accordance with some embodiments of the present disclosure.

FIG. 5 illustrates a block diagram of an exemplary computing device of an intermodal container transportation system in accordance with some embodiments;

FIG. 6A shows a container ship transport of an intermodal shipping container in accordance with some embodiments.

FIG. 6B illustrates the coupling of the SIM containers to the electrical propulsion motor in accordance with some embodiments.

FIG. 7 is a flow chart for a method of transporting an intermodal shipping container via a containership and rail in accordance with some embodiments.

FIG. 8 illustrates a method for powering a vessel carrying a plurality of containers in accordance with some embodiments.

FIG. 9A illustrates a rail transportation system for transporting a SIM container. In accordance with some embodiments.

FIG. 9B illustrates the coupling of the SIM containers to the electrical propulsion motor of a locomotive in accordance with some embodiments.

FIG. 9C illustrates stacked containers interfacing with a rail transportation system for in accordance with some embodiments.

FIG. 10 is a flow chart for a method of transporting a SIM container across a rail leg in accordance with some embodiments.

FIG. 11 is a flow chart for powering a train set transporting one or more SIM containers in accordance with some embodiments.

### DETAILED DESCRIPTION

With reference to the figures, where like elements have been given like numerical designations to facilitate an understanding of the drawings, various embodiments of a system and method are described. The figures are not drawn to scale.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

This description of illustrative embodiments is intended to be read in connection with the accompanying drawings, which are to be considered part of the entire written description. The drawing figures are not necessarily to scale and certain features of the invention can be shown exaggerated in scale or in somewhat schematic form in the interest of clarity and conciseness. In the description of embodiments disclosed herein, any reference to direction or orientation is merely intended for convenience of description and is not intended in any way to limit the scope of the present disclosure. Relative terms such as “horizontal,” “vertical,” “up,” “down,” “top,' and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” “interconnected,” “attached,” and “affixed,” refer to a relationship wherein structures are secured or attached to one another either directly or indirectly through intervening structures, as well as both movable or rigid attachments or relationships, unless expressly described otherwise. The terms “operatively connected” or operatively coupled” are such an attachment, coupling or connection that allows the pertinent structures to operate as intended by virtue of that relationship. The term “adjacent” as used herein to describe the relationship between structures/components includes both direct contact between the respective structures/components referenced and the presence of other intervening structures/components between respective structures/components.

As used herein, use of a singular article such as “a,” “an” and “the” is not intended to exclude pluralities of the article's object unless the context clearly and unambiguously dictates otherwise.

The present disclosure describes an intermodal container having solar PV panels for use in in receiving solar energy. In various embodiments, the intermodal containers further comprise a battery for storing energy received and collected from the solar PV panels. In some embodiments, the intermodal containers described herein may be electrically coupled to each other and/or capable of supplying power to electric vehicles. As will be further explained, although the term intermodal container is used, this disclosure is not limited to intermodal containers, and any type of container may be used as disclosed in the embodiments herein. As an example, a fifty-two inch tractor trailer truck may be understood as a container and/or intermodal container sufficient to encompass the embodiments of this disclosure.

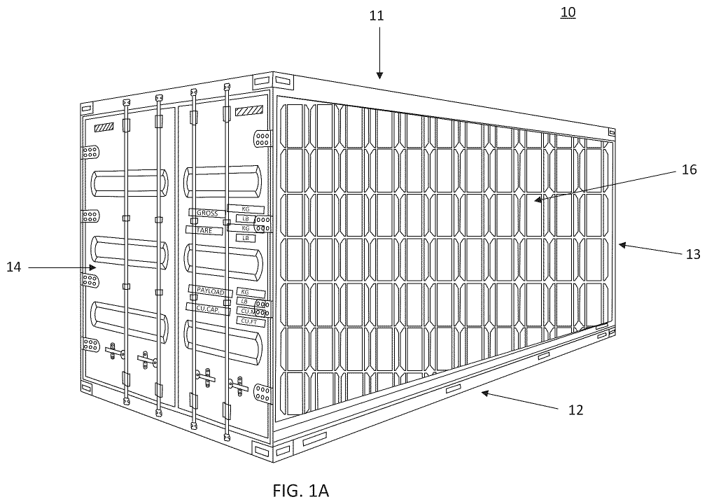

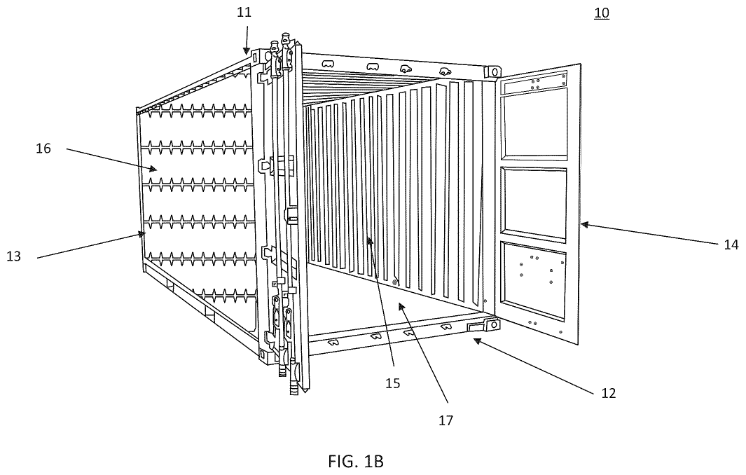

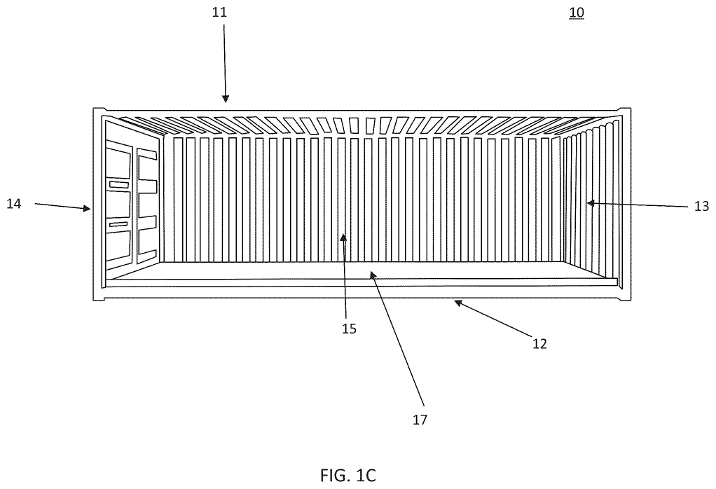

According to various embodiments in the figures, and particular to FIGS. 1A-1C, an intermodal container 10 is illustrated in accordance with some embodiments of the present disclosure. As shown in FIG. 1, intermodal container 10 comprises a top 11, a base 12, and sides 13, defining an interior cavity 15 of the intermodal container. In various embodiments, at least one side is configured with doors 14 to access the interior cavity 15 of the intermodal container.

As shown in FIG. 1, the top 11 and sides 13 of the intermodal container 10 may comprise corrugated interior to aid in support and structure. In various embodiments, the sides top 11, base 12, and sides 13 of intermodal container 10 may be made of metal, high strength plastic, or any suitably rigid and strong material. In some embodiments, intermodal container 10 may be made of metal harder than aluminum with corrosion resistant properties.

As shown in FIG. 1, according to various embodiments of the present disclosure, at least one solar PV panel 16 may be operably coupled to the outer exterior surface of the intermodal container. In various embodiments, a plurality of solar PV panels 16 may be operably coupled to the outer exterior portions of intermodal container 10 sides 13 and/or top 11. In some embodiments, solar PV panels 16 are disposed within a rectangular structure containing sides 13 and solar PV panels 16. In various embodiments, solar PV panels 16 are screwed, bolted, epoxied, mounted, and/or otherwise affixed to sides 13 and/or top 11. A person of ordinary skill in the art would understand that solar PV panels 16 may be operatively coupled to sides 13 and/or top 11 in a variety of different ways.

In various embodiments, the plurality of solar PV panels 16 are electrically coupled together. By way of example, the plurality of solar PV panels 16 may be electrically coupled in series or parallel. Solar PV panels 16 may comprise a plurality of solar cells wired together. By way of example, solar PV panels 16 may be made up of 60, 72, or 96 solar cells wired together. Solar PV panels 16 may be monocrystalline solar panels (Mono-SI), polycrystalline solar panels (Poly-SI), thin-film solar cells (TFSC), amorphous silicon solar cell (A-Si), biohybrid solar cell, cadmium telluride solar cell (CdTe), or concentrated PV cell (CVP or HCVP).

In some embodiments, solar PV panels 16 may comprise a solar skin. In various embodiments, the solar skin comprises aesthetic features useful for identifying intermodal container 10. In some embodiments, solar PV panels 16 comprise a solar skin on the outer exterior surface for identifying intermodal container 10 according to the ISO 6346 international standard. By way of example, information used to identify intermodal container may comprise, but is not limited to, serial number (with or without check digit), owner, country code, size, type and equipment category as well as any operational marks.

As shown in FIG. 1, according to various embodiments, intermodal container 10 further comprises a battery 17. In some embodiments, base 12 comprises an interior cavity where battery 17 may be stored. In various embodiments, battery 17 may comprise a structure similar to base 12 which defines the inner cavity 15 of intermodal container 10. According to various embodiments, battery 17 is electrically coupled to at least one solar PV panel 16 and configured to store solar energy collected from solar PV panel 16. In some embodiments, battery 17 is configured to be electrically coupled to a plurality of solar PV panels 16 and store solar energy collected from solar PV panel 16.

According to various embodiments, battery 17 may be of various capacity. Capacity as used herein refers to the total amount of electricity that the battery can store, typically measured in kilowatt-hours (kWh). In some embodiments, battery 17 may be disposed in a battery compartment (not shown) for housing battery 17. In various embodiments, battery 17 may be stackable (i.e., may include multiple batteries with solar-plus-storage system to get extra capacity). In some embodiments, battery 17 may have of various power ratings (i.e., the amount of electricity that a battery can deliver at one time).

Battery 17 may comprise various chemical compositions (e.g., lead acid, lithium ion, nickel cadmium, saltwater etc.). Battery 17 consist of different lifespans, depth of charge, or other characteristic as would be understood by one of ordinary skill in the art. Although different battery types are disclosed, a person of ordinary skill in the art would understand that batteries may be made of many different materials and suitable for storing solar energy collected from solar PV panels 16 as described in this disclosure.

According to various embodiments, battery 17 may be electrically coupled to solar PV panels 16. In some embodiments, battery 17 is electrically coupled to solar PV panels 16 via a charge controller. In some embodiments, battery 17 may be connected to a power inverter. The power inverter as described herein takes DC power, either from the solar PV panels 16 directly or battery 17, and converts it into AC power.

### Interfaces

In various embodiments, intermodal container 10 may comprise at least one electrical connection for electrically connecting two intermodal containers 10 together.

In various embodiments, a plurality of electrical connections are disposed on the corners of either the top 11 or the bottom 12 of intermodal containers 10. According to various embodiments, the electrical connections may permit wireless power transfer from a battery 17 of intermodal container 10 to another battery of a different intermodal container. In this example, the electrical connection may provide the respective batteries 17 of a plurality of intermodal containers 10 to be wired in series or parallel. In various embodiments, intermodal container 10 may comprise a connection port for connecting two intermodal containers 10 together. In some embodiments, a plurality of connection ports may be integrated or disposed on intermodal container 10 such that a female or male connection aligns to a male or female connection in the same location when two intermodal containers are stacked on top of each other. By way of example, a top 11 portion of an intermodal container may comprise at least one female port and a bottom 12 portion of an intermodal container may comprise at least one male port. In this example, the connection ports permit electrically coupling two intermodal containers in series or parallel. In various embodiments, intermodal container 10 comprises a pressure switch. In some embodiments, the pressure switch is configured to open an access panel when intermodal containers 10 are stacked on top of each other. In some embodiments, connection ports are disposed behind an access panel such that when an intermodal container 10 is stacked on top of another intermodal container, the access panel opens and two intermodal containers 10 are electrically connected via the connection port.

Embodiments also include contactless interfaces that electrically connecting the intermodal shipping container to the prime mover of the respective transportation systems (e.g. rail, sea, land or air).: The wireless interface between the containers and the transportation systems include an induction coil preferably positioned on a bottom surface of the intermodal shipping container and within the ISO container envelope, as to ensures its compatibility with each of the transport modes. The induction coil interacts with second induction coil on a container receiving area of the transportation system, for example the rail car bed, cargo bay, semi-trailer bed, air transportation pallets. The induction coils are disposed face to face to allow power to be wirelessly transferred.

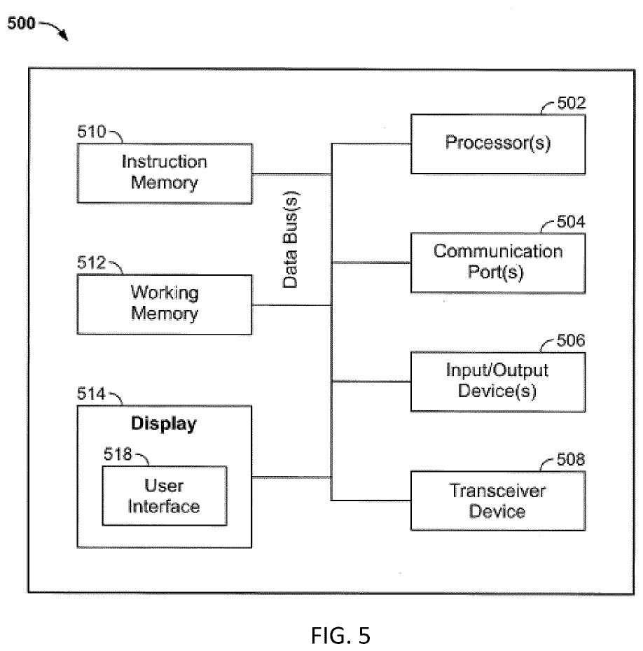

The interfaces may also include inverters and rectifiers for conditioning the power between AC and DC, given solar panels and battery supply power via DC and inductors generally require AC in order to continuously transport power to an associated inductor. The prime movers of the transportation system may utilize propulsive motors using either DC and AC, although most utilize DC. Similar interfaces may be used to connect the container to a second container especially in a stacked configuration, in which a second inductor interface is located on the top surface for interacting with an inductor interface on the bottom surface of the second container. Additional containers may be stack upon the second container and electrically connected in the same manner. In addition to power transport to and from the containers, signaling may also be transmitter across the inductor interfaces. The interfaces may be controlled by a co-located or remote computer processors. A suitable processor is described with respect of FIG. 5.

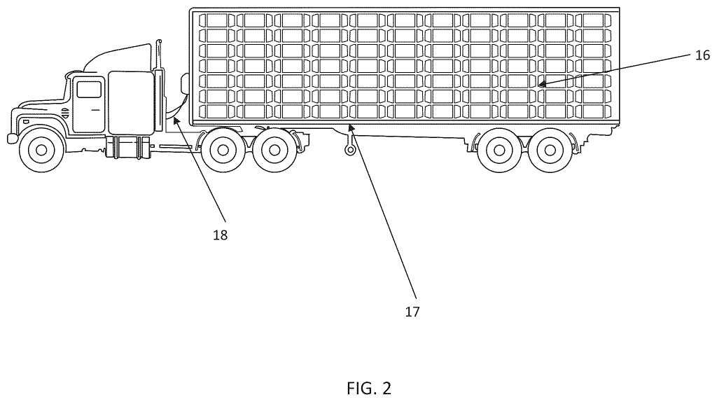

FIG. 2 is an intermodal container operably coupled to a truck in accordance with some embodiments of the present disclosure. In various embodiments, intermodal container 10 is configured to be physically and electrically coupled to a truck or semi-truck. In some embodiments, intermodal container 10 is electrically coupled to a truck or semi-truck via a trailer receptacle plug 18. In this embodiment, the battery 17 of intermodal container 10 is electrically coupled to the truck or semi-truck via a receptacle plug 18. In various embodiments, the receptacle plug 18 is defined by SAE recommended practice J560 standards. In other embodiments, intermodal container 10 may be electrically coupled to a truck or semi-truck via any suitable electronic connection means.

According to various embodiments of the present disclosure, intermodal containers 10 can advantageously power electrical motors, hybrid/electric engines or electric drive units from the power stored in battery 17. In various embodiments, intermodal containers 10 can power AC internal permanent magnet motors. In this example, at least one intermodal container 10 is electrically coupled to the electric or hybrid electric motor of a vehicle. In some embodiments, a plurality of intermodal containers 10 are electrically coupled together and configured to supply power from respective batteries 17 to

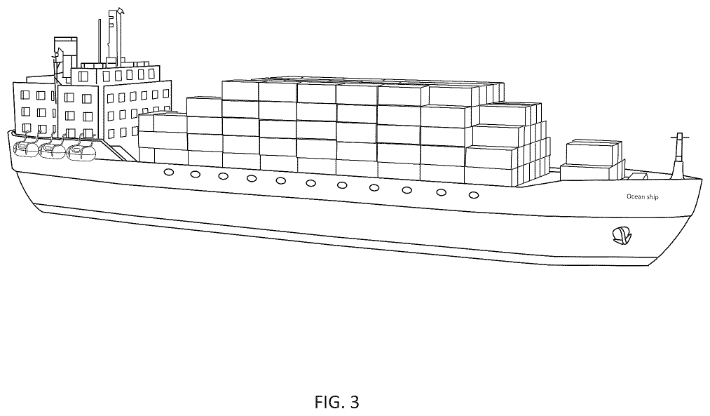

FIG. 3 is a plurality of intermodal containers disposed on a container ship in accordance with some embodiments of the present disclosure. In various embodiments, intermodal containers 10 may be electrically coupled to each other. As explained above, receptacle plug 18, which is defined by SAE recommended practice J560 standards, may be operably coupled to a corner of intermodal container 10. In various embodiments, a plurality of male and female ends of receptacle plug 18 may be operably coupled to the corners of intermodal container. In this embodiment, when a container 10 is disposed over another container 10, the male and female ends of receptacle plug 18 may be jointed. In various embodiments, a plurality of access panels (not shown) are disposed on intermodal container 10. The access panels may be used to protect the male and female ends of receptacle plugs 18 and triggered to open from the pressure of one intermodal container 10 being stacked on another intermodal container 10. As noted above, wireless interfaces are also envisioned.

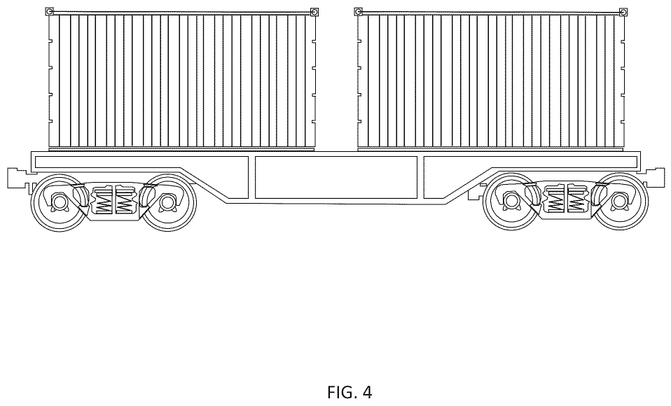

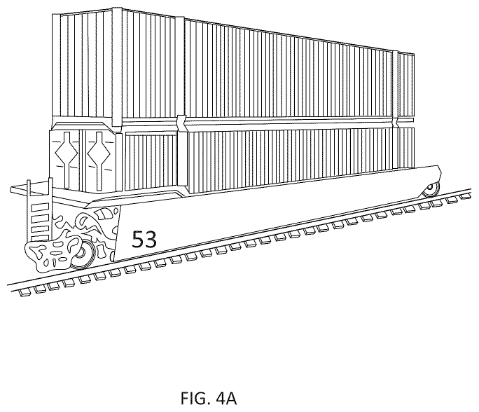

FIG. 4 is a plurality of intermodal containers disposed on railroad car in accordance with some embodiments of the present disclosure. FIG. 4A is a plurality of intermodal containers disposed on each other on railroad car in accordance with some embodiments of the present disclosure. In various embodiments, storage capacity of battery 17 of intermodal container 10 may be viewed on a gauge or digital readout panel of intermodal container 10. In some embodiments, storage capacity of battery 17 may be communicated wireless to a mobile device. In this embodiment, intermodal container 10 may contain a processor and a communication interface or circuitry for transmitting battery 17 storage information to a mobile device. The communication interface may include a wireless interface configured for short range communication, such as near field communication (“NFC”), Bluetooth, or other interface for communication via another wireless communication protocol configured to communicate with a mobile device or computer. Power transfer may be via the multiple interfaces as described herein.

### Containerships

An electric container ship would be powered by the hundreds of SIM containers loaded aboard the ship, each acting as its own individual solar power plant and battery array for powering the ship, but still functioning as a shipping container. The loading methodology/algorithm for the software utilized to load containerships would follow the following logic. Those dumb containers that are not SIM containers would be loaded closest to the keel and the centerline. After that the algorithm would load the SIM containers with the highest charged batteries from inboard to outboard; then from keel to hatch, leaving the least charged SIM container systems to be above the cargo hold and in the direct sunlight. The logic would draw power from the upper most SEC System Containers during the day to provide direct solar power to the Prime Mover (vessel), and draw from the full powered batteries for the SEC System containers below decks during night transit.

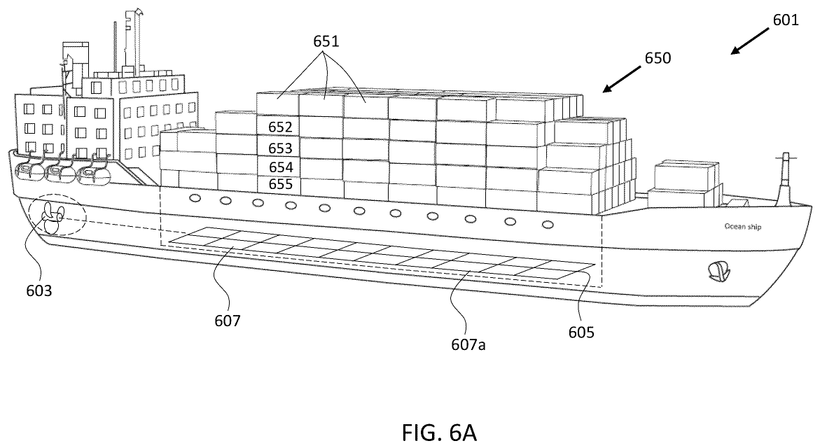

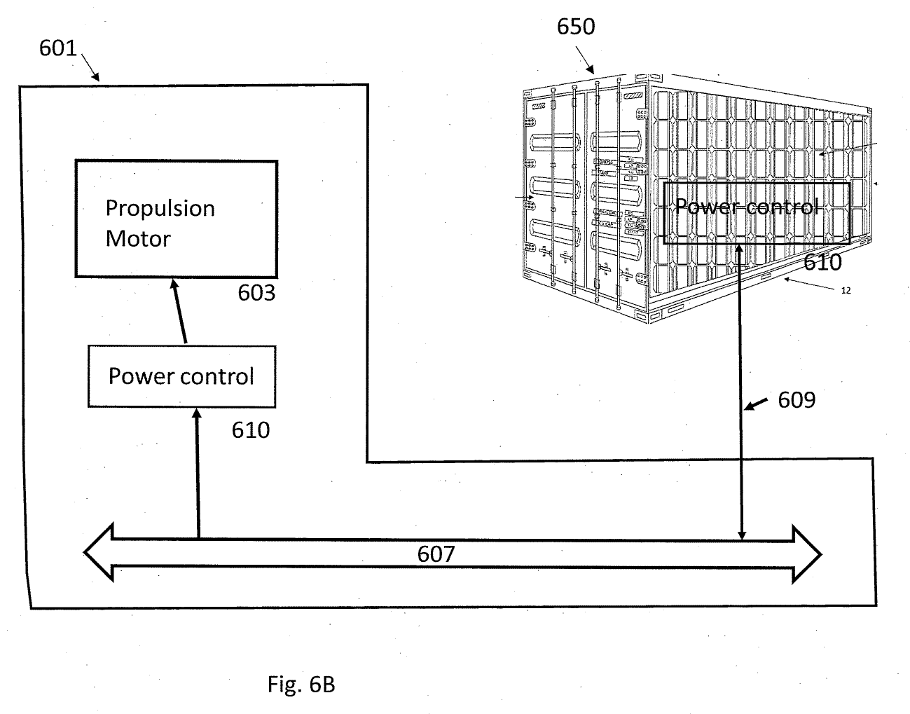

FIG. 6A discloses a transportation system for transporting intermodal shipping containers via containership and another transportation mode (e.g. truck, rail or air). The solar electrified intermodal shipping containers 650 (SIM container) according to embodiments are each of box shape and include a horizontal top, vertical sides and a bottom, and include at least one solar panel on an outer surface of the top and/or sides. The SIM containers 650 include container interfaces 609 electrically connecting the solar panel and, if present, a battery of each of the respective containers.

A container ship 601 is shown which includes an electric propulsion motor 603 and cargo bay, the cargo bay 605 including a power bus 607 in electrical communication with the electric propulsion motor 603 of the ship. The power bus 607 cooperates with the container interface to electrically connect the SIM containers 650 with the electric propulsion motor 603 for assisting in propelling the vessel 601. The power bus 607 may be include parallel or serial branches 607a for connecting each of the containers directly to the propulsive motor 603, or indirectly via interconnected containers (e.g. stacked). For example, the top containers 651 in a stack may electrically communicate with the power bus via relay through the intervening containers 652, 653, 654, 655 . . . to the power bus 607.

The shipping container 650 and/or the container ship 601 may include a regulator or power control system 610 to regulate to regulate electrical power transiting across the cooperating container interface 609 and cargo bay power bus 607. Such control includes preventing power from entering into the shipping container from the cargo bay power bus 607, preventing power from the solar panel from exiting the container to the cargo bay power bus 607. The power control system 610 also may selectively direct/control electrical power generated from the at least one solar panel to one or both of the battery and the container interface 609, and with respect to the battery vice versa. The power control system 610 may also interface with the container ship 601 for aggregate power control of the container array to/from the power bus 607.

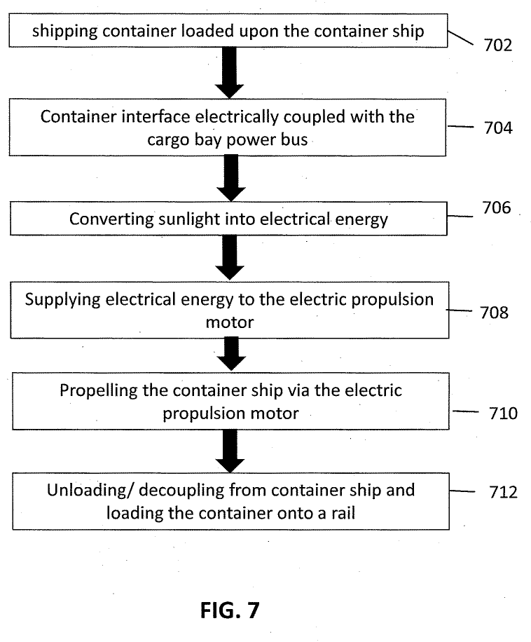

In FIG. 7, a method of transporting an intermodal shipping container via sea across a plurality of legs, including at least one sea leg and another leg via rail is shown. As described above the shipping container includes solar panel affixed to an outer surface of the shipping container and container interface. In Block 702, the shipping container is loaded upon the container ship, subsequently or simultaneous with the loading of the container, the container interface is electrically coupled with the cargo bay power bus of the containership as shown in Block 704. When exposed to the sun, the solar panel converts sunlight into electrical energy as shown in Block 706 and the electrical energy is supplied to the electric propulsion electric motor of the container ship Block 708. The container ship via the electric propulsion motor propels the container ship as shown in Block 710. At least of portion of the power required by the electric propulsion motor to propel the container ship is supplied over the power bus from the solar panel(s) of the container(s) contemporaneous with the conversion of sunlight into electrical energy and propulsion of the container ship overs the at least one sea leg. Upon arrival at the destination port, the container is unloaded and decoupled from the cargo bay power bus. The container may then be loaded upon a rail car as shown in Block 712. It should be understood, the second leg while shown as rail, may also be another sea leg, a road leg or air leg.

In certain circumstances, the converted electrical energy from the solar panel(s) may be stored within a battery associated with the shipping container and the stored energy in the battery may also be provided to the electric propulsion motor. Prior to loading, the shipping container may preferably convert sunlight into electrical energy in the yard and store that converted electrical energy in the battery for subsequent use by the container ship. It is envisioned and in practice, multiple containers are loaded upon the container ship and each of the containers, if so equipped may electrically communicate with the power bus and thus participate in the propulsion of the vessel.

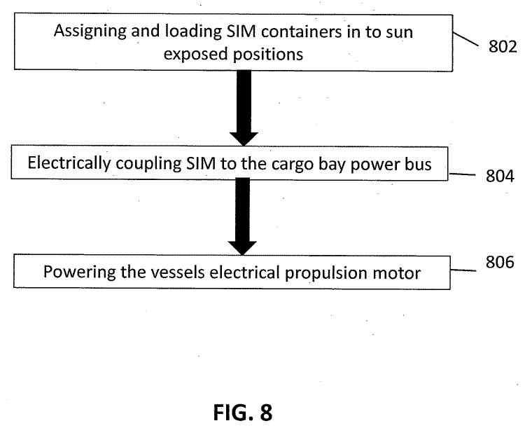

FIG. 8 illustrates a method for powering a vessel carrying a plurality of containers each equipped with a solar panel and interface as previously described. A set of shipping containers are assigned and subsequently loaded into positions upon the vessel which would be exposed to natural light during transport as shown in Block 802. Subsequently or simultaneously with the loading the set of shipping containers are electrically coupled to the cargo bay power bus of the vessel shown in Block 804. It should be understood that a subset of containers on an upper level may be connected to the power bus via intervening shipping containers at lower level positions. The Powering the vessels electrical propulsion motor at least in part, via the set of shipping containers, via the power bus.

### Railcars

Similarly, as with the loading of the containership, freight trains may be electrically powered at least in part using the SIM containers. Instead of the current diesel standard, the mile-long double stacked SIM containers loaded on the train may be daisy-chained together to power the lead locomotives. Liken to the steam locomotives that utilized a tender or coal-car to haul its fuel and water, the SIM System would allow for multiple SIM containers to be attached directly to the EV Prime Mover. When building the train in the yard, the quantity of SIM containers needed would be calculated by the yard master based on the distance to destination, grades to be traversed, length, and weight of the train. Cars in a railroad yard may be sorted by numerous categories, including railroad company, loaded or unloaded, destination, car type. There are about 10 different categories of rail cars to include: auto-racks, boxcars, refrigerated boxcars, center-beam, covered hoppers, open-top hoppers gondolas, tank cars, flat cars, coil cars, and well cars for intermodal containers. The yard management software's algorithm would consider each type of car going into the train with their respective weight and destination.

The SIM containers requiring transport would preferably be attached to the Prime Mover regardless of being built in a classification, flat, hump, receiving, or transload yard. The SIM containers may even be attached to the switchers, which are the Prime Movers working in the yard to build the train, as well as “locals” that service various customers. For example, 3 GE Prime Movers (e.g. C44-9W) would be directly attached to 5 well cars loaded with 10 double stacked SIM System Containers to pull a 175 car coal train (open-top hopper). The power needed to enable the Prime Mover to pull the entire train may be augmented by the direct solar power pulled from the SIM System containers contemporaneous with the transport or from stored energy within the batteries resident in the SIM containers. Power for the Prime Mover would be drawn in a destination focused method. Those SIM System Containers slated for the first stop would have battery power drawn first, while those SIM System Containers slated for the end of the line would be last to have battery power drawn from them. For direct trips with no intermediate stops, the power sequence may be based on battery usage, drawing from the SIM System Containers with fuller charges down to the lowest charges. It is envisioned that the prime movers would also be supplied with power via conventional means (e.g. diesel generators) with the SIM containers augmenting the power requirements to the extent possible. For example, in short haul scenario the SIM containers, via solar conversion along with stored energy in the batteries may be able to supply power for the entire trip, whereas in longer hauls, or on longer trains the SIM containers may only provide a fraction of the power requirements.

It is also envisioned that the power draw order may be a function of the next leg of the SIM container. For example, if on the next leg, the stored energy of in the battery may be more efficiently or economically used by another prime mover, or transportation mode, respective SIM container assigned to the next leg may not be drawn from, or be placed further down on the order. However, it another scenario in which the prime mover in the following leg is not configured to drawn from the SIM container, the SIM container may be prioritized to be drawn down, since it would not be able to assist in powering the following leg. The draw order, while primarily driven with respect to the energy stored in the battery, may also be a function of the performance of the respective solar panel system. The batteries of SIM containers that are more readily capable of recharging them in minimum amount of time may be ranked higher in the order than those SIM containers in which the batteries are not as quickly recharged by the respective solar system.

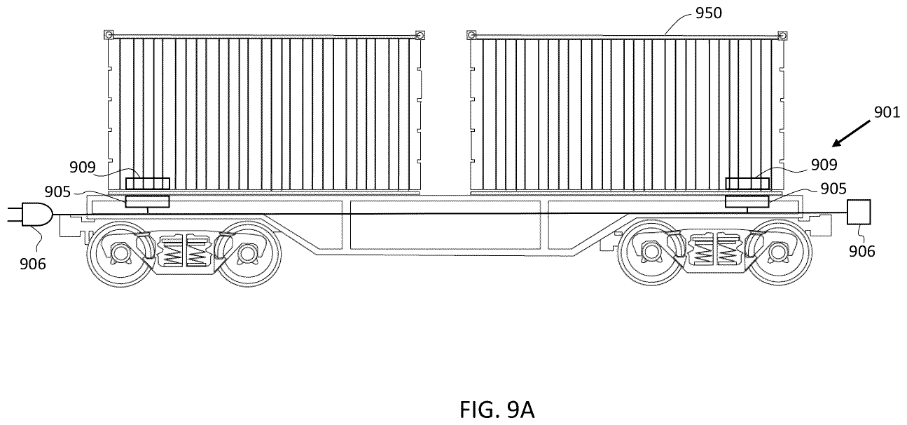

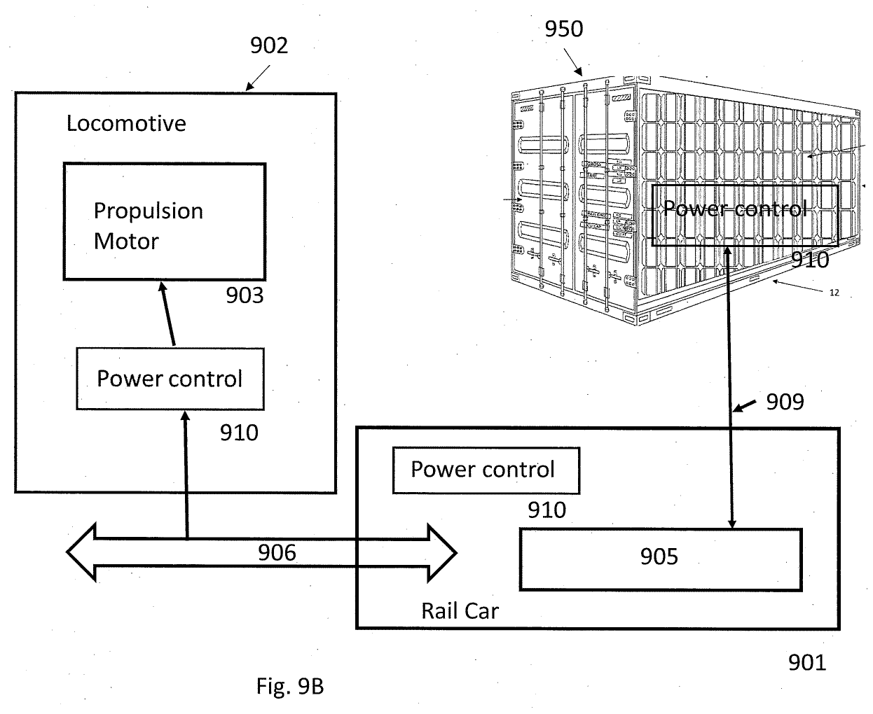

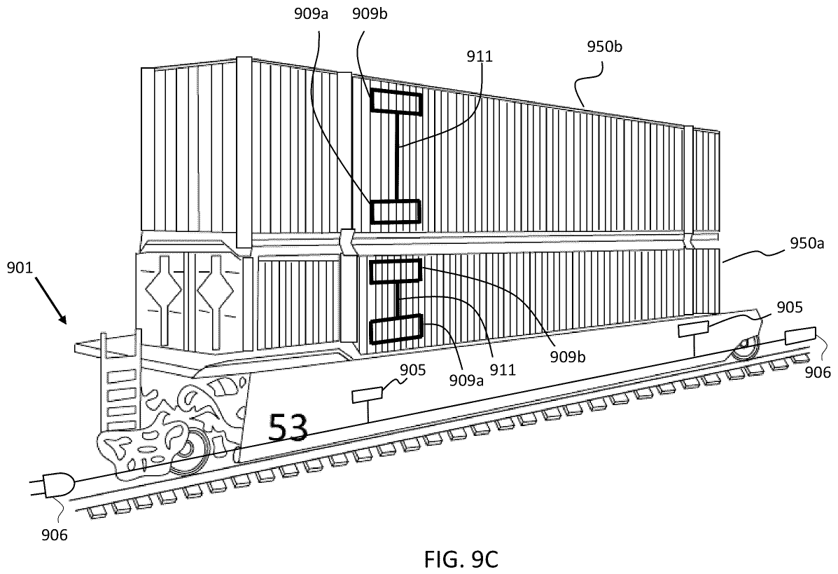

FIG. 9A illustrates a rail transportation system for transporting a SIM container. The rail transportation system includes a locomotive driven by an electric propulsion motor and at least one rail car 901 configured to interface with the SIM container 950. The rail transportation system is envisioned to include a plurality of rail cars 901 that interface with the SIM containers 950 as well as additional rail cars not equipped to carry containers or not configured to interface with the SIM containers. The rail cars so equipped each include at least one rail car interface 905 and at least one rail car coupling 906. The rail car couplings 906 preferably in the front and the back of each rail served to electrically connect the electric propulsion motor 903 and the rail car interface 905, from rail car to rail car to locomotive 902. The rail car interface 905 cooperating with the container interface 909 of the SIM container 950 to electrically connect the container interface 909 via the rail car couplings 906 with the electric propulsion motor 903. The connection of rail car couplings 906 from one rail car to another create a power bus for the distribution of power to and from the SIM container 950. Preferably, the rail cars 901 have two rail car interfaces 905 as two SIM containers may fit on the rail car bed, any stacked SIM containers may be electrically coupled to the rail car interface 905 via the bottom SIM container.

As noted previously, the SIM containers 950 or the locomotive 902 may include a regulator or power control system 910 for controlling internal power distribution and well as power transmission across the rail car interface 905, as illustrated in FIG. 9B. The power control system 910 may also be in communication with the rail system to control the aggregate power provided by the SIM containers 950 to the electric propulsion motor 903.

FIG. 9C illustrates an embodiment in which the SIM containers 950 a, b are stacked on the rail car 901. The stacked containers 950 a, b interface with each other via the container interfaces 909 a, b. The container interface 909a of the top container 950b communicates electrically with the container interface 909b of the lower container 950a and via bus 911, and with the rail car interface 905 via the container interface 909a of the lower SIM container. The rail car interface 905 cooperating with the container interface 909a of the lower SIM container 950a to electrically connect both the bottom and top containers via the rail car couplings 906 with the electric propulsion motor 903. Stacked containers may similarly be connected to the cargo bay power bus in other transportation modes such as described above with respect to container ships.

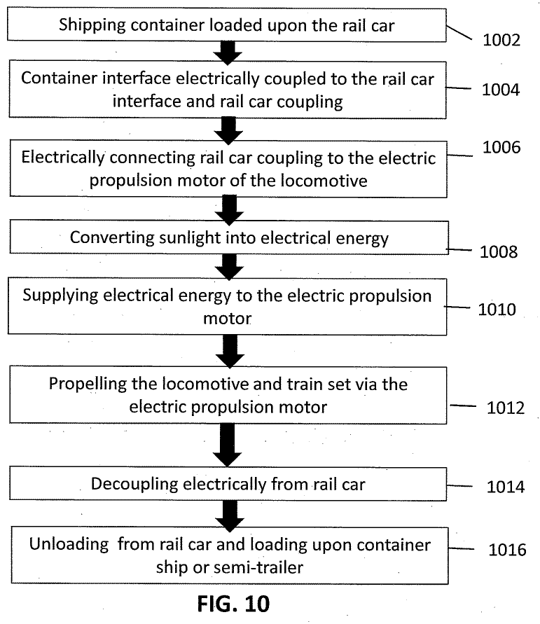

FIG. 10 describes the operation of the rail transportation system in transporting a SIM container across a rail leg and a sea leg. In Block 1002 the SIM container is loaded onto a rail car having one or more rail car interfaces and one or more rail car couplings. Contemporaneously or subsequent to the loading, the container interface may be connected to the rail car interface and thus the rail car coupling as shown in Block 1004. In Block 1006, the rail car coupling is electrically coupled to the electric propulsion motor of the locomotive. Respective rail car couplings connect each of the rail cars electrically together and connect them to the locomotive.

The SIM containers convert sunlight into electrical energy via the at their respective solar panels and that electrical energy is supplied to the electric propulsion electric motor of the locomotive via the container interface, rail car interface and rail car coupling as shown in Blocks 1008 and 1010. The locomotive propels the train set including the rail cars carrying SIM containers as well as other the rail cars, powered at least in part by energy supplied from the SIM containers' solar panels contemporaneous with the conversion of sunlight into electrical energy as shown in Block 1012. At the end of the rail leg, the SIM containers are decoupled and unloaded from the rail car as shown in Blocks 1014 and 1016. The SIM containers may then be move to a yard or loaded upon a container ship container or semi-trailer.

In addition to the power provided via the SIM containers' conversion of sunlight, energy stored the within a battery associated with the SIM container may also be supplied over the power bus to the electric propulsion motor. Double stacking SIM containers on a rail car is envisioned and thus the upper SIM container may be connected to the electric propulsion motor via the base SIM container.

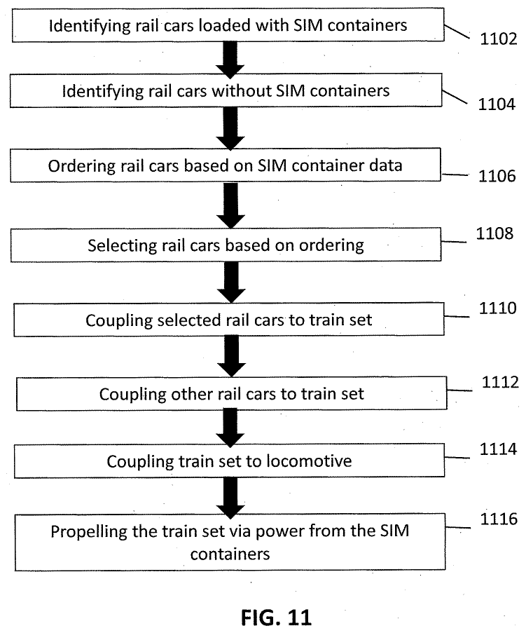

FIG. 11 is a flow chart for powering a train set transporting one or more SIM containers. In Block 1102, rail cars loaded with at least one SIM container are identified. The identification may be via normal categorizing processes used in the rail industry and used by the hump yard to create the train sets. A second set of rail cars are also identified, these being rail cars without a SIM container in Block 1104.

The identification may include retrieving data associated with each of the SIM containers, the data may include shipping destination, battery capacity, battery charge, solar panel power output, next transportation mode, next leg prime mover (e.g. locomotive, ship, truck, etc.) and solar panel arrangement. The containers may be ordered based on this data as shown in Block 1106. The battery charge and the panel power output preferably form the primary basis for the ordering.

The rail yard then selects two rail cars identified as having a SIM container based on the order in Block 1108, and the brakeman couples physically and electrically the selected rail cars to the train set as shown in Block 1110. The brakeman also couples other rail car from the second set to the train set as shown in Block 1112. The brakeman couples the train set to the locomotive with the rail cars with SIM containers closer to the locomotive in Block 1114. The locomotive then propels the train set via at least in part with power from the SIM containers, either via the contemporaneous solar power conversion or via the respective SIM container batteries as shown in Block 1116.

### Semi-Trucks/Semi-Trailers

Lastly any EV semi-truck may be at least partially powered by its own SIM container load providing additional range. Both the SIM container battery and the solar panels may be used contemporaneous during transport to at least partially power the EV semi-truck, while during stops may be used to recharge the EV semi-trunks installed battery. Only minimal retrofitting of the vehicle is required to the semi-truck and thus does not impact or interfere with the transportation of traditional non-SIM containers. Additionally, for extended trips, the SIM battery may also be recharged at charging stations while the installed battery of the EV semi-truck is also being charged. A power controller associated with the truck or SIM container, and in electrical communication with both, may control the charging of the SIM container battery.

Additionally, it is envisioned that conventional box trailers may also benefit from the addition of solar panels and respective interfaces with the semi-truck and or other transportation system. Conventional box trailers are often transported by rail, and thus could interface with the rail car in a similar manner as described for shipping containers.

### Yards

IM containers while not actively being transported are typically stored with other IM containers in large yards, Depots, docks and rail yards often serve as temporary yards for IM container in between legs, as well as while transitioning between transportation nodes. The same power networking of the SIM containers as used during transport of ships and rails may also be used for SIM containers in the yards. By interconnecting the SIM containers, the power controllers associated with the SIM containers may collectively charge the batteries of the SIM containers, even when specific SIM container are shaded (e.g. buried within the stack or on the pole side of the stack) As understood, much like a full tank of gas, a fully charged SIM container battery is beneficial, in that the next leg may benefit from the power stored within. Additionally, while at a yard, the SIM container may also be used for external loads (e.g. security lighting, facility loads, forklift recharging etc.)

FIG. 5 illustrates a block diagram of an exemplary computing device 500 of a power controller/interface in accordance with some embodiments. The computing device 500 may be employed by a disclosed system or used to in part in the execution of the disclosed methods. For example, computing device 500 may be a computing device 500 configured to control the charging, discharging, voltage, amperage and or isolation of the SIM container and or its interface with the transportation mode, as well as controlling power transformation between AC and DC and AC and vice versa. An external device such as a smartphone or remote, may be configured to wirelessly communicate with computing device 500. It should be understood, however, that other computing device 500 configurations, including distributed and/or cloud-based systems, are possible.

Computing device 500 may include one or more processors 502, one or more communication port(s) 504, one or more input/output devices 506, a transceiver device 508, instruction memory 510, working memory 512, and optionally a display 514, all operatively coupled to one or more data buses 516. Data buses 516 allow for communication among the various devices, processor(s) 502, instruction memory 510, working memory 512, communication port(s) 504, and/or display 514. Data buses 516 may include wired, or wireless, communication channels. Data buses 516 are connected to one or more devices.

Processor(s) 502 may include one or more distinct processors, each having one or more cores. Each of the distinct processors 502 may have the same or different structures. Processor(s) 502 may include one or more central processing units (CPUs), one or more graphics processing units (GPUs), application specific integrated circuits (ASICs), digital signal processors (DSPs), and the like.

Processor(s) 502 may be configured to perform a certain function or operation by executing code, stored on instruction memory 510. For example, processor(s) 502 may be configured to perform one or more of any function, method, or operation disclosed herein.

Communication port(s) 504 may include, for example, a serial port such as a universal asynchronous receiver/transmitter (UART) connection, a Universal Serial Bus (USB) connection, or any other suitable communication port or connection. In some examples, communication port(s) 504 allows for the programming of executable instructions in instruction memory 510. In some examples, communication port(s) 504 allow for the transfer, such as uploading or downloading, of data. In some embodiments, a wired or wireless fieldbus or Modbus protocol may be used.

Input/output devices 506 may include any suitable device that allows for data input or output. For example, input/output devices 506 may include one or more of a keyboard, a touchpad, a mouse, a stylus, a touchscreen, a physical button, a speaker, a microphone, or any other suitable input or output device.

Transceiver device 508 may allow for communication with a network, such as a Wi-Fi network, an Ethernet network, a cellular network, radio signals, Bluetooth, or any other suitable communication network. For example, if operating in a cellular network, transceiver device 508 is configured to allow communications with the cellular network. Processor(s) 502 is operable to receive data from, or send data to, a network via transceiver device 508.

Instruction memory 510 may include an instruction memory 510 that may store instructions that may be accessed (e.g., read) and executed by processor(s) 502. For example, the instruction memory 510 may be a non-transitory, computer-readable storage medium such as a read-only memory (ROM), an electrically erasable programmable read-only memory (EEPROM), flash memory, a removable disk, CD-ROM, any non-volatile memory, or any other suitable memory with instructions stored thereon. For example, the instruction memory 510 may store instructions that, when executed by one or more processors 502, cause one or more processors 502 to perform one or more of the operations of the demonstrative model systems 100, 200, 300, 400.

In addition to instruction memory 510, the computing device 500 may also include a working memory 512. Processor(s) 502 may store data to, and read data from, the working memory 512. For example, processor(s) 502 may store a working set of instructions to the working memory 512, such as instructions loaded from the instruction memory 510. Processor(s) 502 may also use the working memory 512 to store dynamic data created during the operation of computing device 500. The working memory 512 may be a random access memory (RAM) such as a static random access memory (SRAM) or dynamic random access memory (DRAM), or any other suitable memory.

Display 514 may be configured to display user interface 518. User interface 518 may enable user interaction with computing device 500. In some examples, a user may interact with user interface 518 by engaging input/output devices 506. In some examples, display 514 may be a touchscreen, where user interface 518 is displayed on the touchscreen.

An aspect of the disclosed subject matter is that while the SIM containers may generate and supply electrical power during daylight hours, the battery may provide power to the prime mover, or other loads during low light conditions or at night. It is also an aspect of the disclosed subject matter that while the SIM container is not in transport its solar panels may function recharge its internal battery or an external load.

Another aspect of the disclosed subject matter is that the connected SIM containers, whether in transport or in a yard, may form an interconnected power network in which load balancing may be performed to charge/discharge the respective batteries of the SIM containers.

An additional aspect of the disclosed subject matter is that the SIM containers are transparent to the conventional transportation assets and distribution network systems. That is the SIM containers may be loaded, handled, transported and unloaded in the same manner using the same equipment as conventional IM containers, but provide additional benefits for those transportation assets configured to interface electrically with the SIM containers. For example, a SIM container maybe transported over rail, ship, air or road by conventional means, where power is never accessed from the SIM container's battery or solar panel, thus it is treated as any other IM container. However, a prime mover on one of the legs may be advantageously configured to access that power as described above.

A yet addition aspect of the disclosed subject matter is that procedures and elements described for one mode of transportation may be equally applicable to the other modes described herein even though an explicit recitation may not be included in the discussion of each mode.

Yet another aspect of the disclosed subject matter is the use of power management at each of the SIM containers individually (e.g. control of charging/discharging the batter, regulation of power output/input, etc.) as well as power management at an aggregate level, where the individual power management of each of the SIM containers is directed by a central controller in communication with the SIM containers as well as the transportation system (e.g. load balancing between the SIM containers, power draw, etc.). The power management at both the individual level (i.e. at the SIM container) and the aggregate level (i.e. network of SIM containers) may preferably utilize computer processor, similar to that described in FIG. 5 above.

It may be emphasized that the above-described embodiments, are merely possible examples of implementations, and merely set forth a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

While various embodiments have been described, it is to be understood that the embodiments described are illustrative only and that the scope of the subject matter is to be accorded a full range of equivalents, many variations and modifications naturally occurring to those of skill in the art from a perusal hereof.

1. A method of transporting an intermodal shipping container across a plurality of legs, including at least one rail leg and another leg via at least of one of a plurality of transportation modes, wherein the shipping container comprises at least one solar panel affixed to an outer surface of the shipping container and the at least one solar panel electrically connected to a container interface, the method comprising:
loading the shipping container onto a rail car, wherein the rail car has at least one rail car interface and at least one rail car coupling, the at least one rail car interface electrically coupled to the at least one rail car coupling;
electrically coupling the container interface with the rail car interface;
electrically coupling the rail car to a train set via the at least one rail car coupling;
electrically coupling the train set to a locomotive having an electric propulsion motor;
converting sunlight into electrical energy via the at least one solar panel;
supplying the electrical energy from the at least one solar panel to the electric propulsion electric motor of the locomotive;
propelling the train set via the electric propulsion motor of the locomotive; wherein at least of portion of the power required by the electric propulsion motor to propel the train set is supplied from the at least one solar panel contemporaneous with the conversion of sunlight into electrical energy via the at least one solar panel and propulsion of the train set over the at least one rail leg;
electrically decoupling the container from the rail car; and,
unloading the container from the rail car at the end of the rail leg.

2. The method of claim 1, further comprising storing the converted electrical energy within a battery associated with the shipping container and wherein the step of propelling the train set via the electric propulsion motor of the locomotive, further comprises supplying the stored electrical energy from the battery to the electric propulsion motor.

3. The method of claim 1, further comprising stacking a second shipping container upon the shipping container, wherein the second shipping container having a second solar panel affixed to a second outer surface of the second shipping container and the second solar panel being electrically connected to a second container interface, and,
electrically coupling the second container interface to the container interface, and wherein the step of propelling the train set via the electric propulsion motor of the locomotive, further comprises converting sunlight into a second portion of electrical energy via the second solar panel and supplying the second portion of electrical energy to the electric propulsion motor of the locomotive via the from the battery to the electric propulsion motor via the container interface contemporaneous with the converting.

4. The method of claim 3, further comprising converting sunlight into electrical energy and storing the electrical energy within a battery associated with the second shipping container prior to stacking the second shipping container on the shipping container and wherein the step of propelling the train set via the electric propulsion motor of the locomotive, further comprises supplying the stored electrical energy from the battery to the electric propulsion motor.

5. The method of claim 1, wherein the step of electrically coupling the rail car to a train set via the at least one rail car coupling; further comprises:
electrically coupling the rail car to a second rail car in the train set via a second rail car coupling associated with the second rail car, and the rail car coupling, and electrically coupling a third rail car coupling associated with the second rail car with the second rail car coupling.

6. The method of claim 1, wherein the train set includes a second rail car between the rail car and the locomotive.

7. The method of claim 6, further comprising
loading a second shipping container onto the second rail car, wherein the second shipping container having a second solar panel affixed to a second outer surface of the second shipping container and the second solar panel being electrically connected to a second container interface;
the second rail car having a second rail car interface, a second rail car coupling and a third rail car coupling, the second rail car interface electrically coupled to the third rail car coupling;
electrically coupling the second container interface with the second rail car interface;
electrically coupling the second rail car to the train set via the second rail car coupling;
electrically coupling the third rail car coupling to the rail car coupling;
converting sunlight into electrical energy via the second solar panel;
supplying the electrical energy from the second solar panel to the electric propulsion electric motor of the locomotive;
wherein a second portion of the power required by the electric propulsion motor to propel the train set is supplied from the second solar panel contemporaneous with the conversion of sunlight into electrical energy via the second solar panel.

8. The method of claim 2, wherein prior to loading the shipping container on the rail car converting sunlight into electrical energy and storing the converted electrical energy in the battery.

9. The method of claim 1, further comprising loading the shipping container on a container ship.

10. A transportation system comprising:
an intermodal shipping container;
a first transportation subsystem configured to transport the intermodal shipping container via rail; and,
a second transportation subsystem configured to transport the intermodal shipping container via one of a plurality of modes selected from the group consisting of truck; sea and air;
the intermodal shipping container comprising:
a horizontal top, two vertical sides;
at least one solar panel on an outer surface of the container defined by the horizontal top and two vertical sides;
a container interface in electrical communication with the at least one solar panel;
the first transportation subsystem comprising:
a locomotive including an electric propulsion motor and a rail car, the rail car having a rail car interface and a rail car coupling, the rail car coupling in electrical communication with the electric propulsion motor and the rail car interface; the rail car interface cooperating with the container interface to electrically connect the container interface with the electric propulsion motor.

11. The transportation system of claim 10, further comprising a regulator associated with the shipping container and in communication with the first transportation subsystem, the regulator configured to regulate electrical power transiting across the cooperating container interface and rail car interface.

12. The transportation system of claim 11, wherein the regulator prevents power from entering into the shipping container from the rail car interface.

13. The transportation system of claim 11, wherein the regulator prevents power from the at least one solar panel from exiting to the rail car interface.

14. The transportation system of claim 10, wherein the intermodal shipping container comprises a battery and a power control system, wherein the power control system selectively directs electrical power generated from the at least one solar panel to one or both of the battery and the container interface.

15. The transportation system of claim 14, wherein the power control system is configured to be in communication with the first transportation subsystem, and configured to selectively regulates power entering the battery from the rail car interface.

16. The transportation system of claim 10, wherein the rail car interface and rail car coupling form a power bus.

17. A method of powering an engine capable of receiving electricity, comprising the steps of:
receiving solar energy via at least one solar panel operably coupled to the exterior surface of a first intermodal container;
storing the solar energy received via the at least one solar panel in a battery disposed within an interior cavity of a container;
supplying power to an electric or hybrid electric engine using the stored solar energy from the battery.

18. The method of claim 17, further comprising the steps of:
stacking a second intermodal container onto said first intermodal container; electrically coupling the battery of the first intermodal container and with a battery disposed within an interior cavity of the second intermodal containers via at least one plug receptacle;
supplying power to an electric or hybrid electric engine using the stored solar energy from each respective battery of the first and second intermodal containers.

19. The method of claim 17, wherein supplying power to an electric or hybrid electric engine is via an engine plug receptacle electrically coupled to a battery of the first or second intermodal container.

20. The method of claim 19, wherein the battery of the first and second intermodal container is disposed in a planar battery compartment.

21. A method of powering a train set, comprising:
providing set of rail cars loaded with at least one of a solar electrified intermodal shipping container, wherein each of the solar electrified intermodal shipping containers comprise:
a horizontal top, two vertical sides;
at least one solar panel on an outer surface of the container defined by the horizontal top and two vertical sides;
a battery;
a container interface in electrical communication with the at least one solar panel, the battery and the respective rail car;
providing a second set of rail cars;
selecting a first rail car and a second rail car from the set based on a predetermined order;
coupling the first rail car to the second rail car to form a first set,
coupling a third rail car from the second set of rail cars to the first set;
coupling the first set to a locomotive; and,
powering the locomotive, at least in part, via the solar electrified shipping containers on the first rail car and second rail car.

22. The method of claim 21, wherein the step of selecting comprises determining the stored energy in each of the batteries of the respective solar electrified intermodal shipping containers and wherein the predetermined order is a function of the stored energy.

23. The method of claim 21, wherein the step of selecting comprises determining data associated with each of the solar electrified shipping containers, the data being selected from the group comprising shipping destination, battery capacity, battery charge, solar panel power output, next transportation mode, next leg prime mover and solar panel arrangement.

24. The method of claim 21, wherein the step of selecting a first rail car and a second rail car from the set based on a predetermined order, further comprises selecting a fourth rail car from the set based on the predetermined order and wherein the set of coupling the first rail car to the second of the rail car to form a first set further comprises coupling the fourth rail car to the first and second rail cars to form the first set, and powering the locomotive, at least in a second part, via the solar electrified shipping containers on the fourth rail car.

25-46. (canceled)
